(19) United States
(12) Patent Application Publication
(10) Pub. No.: US 2023/0216048 A1
(43) Pub. Date: Jul. 6, 2023

(54) PRODUCTION METHOD OF LITHIUM COBALT PYROPHOSPHATE, AND PRODUCTION METHOD OF SOLID-STATE BATTERY

(71) Applicants: FDK CORPORATION, Tokyo (JP); Kansai Catalyst Co., Ltd., Osaka (JP)

(72) Inventors: Juji KATO, Tokyo (JP); Tomohiro FUJISAWA, Tokyo (JP); Yuji GOTO, Tokyo (JP); Kouichi HASHIMOTO, Osaka (JP)

(73) Assignees: FDK CORPORATION, Tokyo (JP); Kansai Catalyst Co., Ltd., Osaka (JP)

(21) Appl. No.: 17/927,682

(22) PCT Filed: May 20, 2021
(86) PCT No.: PCT/JP2021/019246

§ 371 Date: Nov. 23, 2022

(30) Foreign Application Priority Data
May 25, 2020 (JP) 2020-090477

(51) Int. Cl. H01M 4/58; H01M 10/058; C01B 25/45

(52) U.S. Cl. CPC H01M 4/5825; H01M 10/058; C01B 25/45; H01M 2004/028

(57) ABSTRACT

This method achieves lithium cobalt pyrophosphate in which the generation of different phases is suppressed. A powder of a lithium compound, a cobalt compound and a phosphorus compound in amounts based on the composition of lithium cobalt pyrophosphate is mixed while adding water at a prescribed temperature (T1), for example, room temperature, and the substance obtained thereby is further mixed at a higher temperature (T2), for example, 40° C.-60° C. In this way, a precursor of lithium cobalt pyrophosphate is formed that has excellent uniformity of distribution of the lithium component, the cobalt component and the phosphorus component. By firing such a precursor, a lithium cobalt pyrophosphate is obtained in which the generation of different phases is suppressed.

### TECHNICAL FIELD

The present invention relates to a production method of lithium cobalt pyrophosphate and a production method of a solid-state battery.

### RELATED ART

A technique of using lithium cobalt pyrophosphate (Li₂CoP₂O₇) as the positive electrode active material of a solid-state battery is known.

A dry production process is known as a production method of lithium cobalt pyrophosphate, in which the raw materials are mixed and the mixed raw materials are fired under predetermined conditions to obtain lithium cobalt pyrophosphate, for example. A wet production process is also known, in which an aqueous solution is obtained by mixing the raw materials with citric acid and then a powder obtained by drying the aqueous solution is fired under predetermined conditions to obtain lithium cobalt pyrophosphate, for example.

### CITATION LIST

### Patent Literatures

[Patent Literature 1] Japanese Patent Laid-Open No. 2017-182949

[Patent Literature 2] Japanese Patent Laid-Open No. 2019-149302

### SUMMARY OF INVENTION

### Technical Problem

It is known that, in the production of lithium cobalt pyrophosphate, a crystalline phase (also referred to as “heterogeneous phase”) different from the desired crystalline phase of lithium cobalt pyrophosphate can be generated. The generation of such a different phase may cause inconvenience in utilizing the lithium cobalt pyrophosphate. For example, in the case of trying to use lithium cobalt pyrophosphate as the positive electrode active material of a solid-state battery as described above, if the positive electrode active material contains a heterogeneous phase different from that of lithium cobalt pyrophosphate, it may not be possible to obtain a solid-state battery that exhibits sufficient charge/discharge characteristics.

In one aspect, an object of the present invention is to realize lithium cobalt pyrophosphate in which the generation of different phases is suppressed.

### Solution to Problem

In one aspect, a production method of lithium cobalt pyrophosphate is provided, including: a step of preparing powders of a lithium compound, a cobalt compound, and a phosphorus compound in amounts based on a composition of lithium cobalt pyrophosphate at a first temperature, and mixing while adding water at the first temperature to obtain a first material; a step of mixing the first material at a second temperature higher than the first temperature to obtain a second material; and a step of firing the second material at a third temperature higher than the second temperature.

Further, in one aspect, a production method of lithium cobalt pyrophosphate is provided, including: a step of preparing powders of a lithium compound, a cobalt compound, and a phosphorus compound in amounts based on a composition of lithium cobalt pyrophosphate at a first temperature, and mixing while adding water at a second temperature higher than the first temperature to obtain a first material; and a step of firing the first material at a third temperature higher than the second temperature.

Furthermore, in one aspect, a production method of a solid-state battery is provided, which contains the lithium cobalt pyrophosphate produced as described above as a positive electrode active material.

### Effects of Invention

In one aspect, it is possible to realize lithium cobalt pyrophosphate in which the generation of different phases is suppressed. Further, it is possible to realize a solid-state battery that includes lithium cobalt pyrophosphate in which the generation of different phases is suppressed as a positive electrode active material and exhibits excellent charge/discharge characteristics.

The objects, features, and advantages of the present invention will become clear with reference to the following description in conjunction with the accompanying drawings which represent preferred embodiments as examples of the present invention.

### BRIEF DESCRIPTION OF DRAWINGS

FIG. 1 is a diagram illustrating the production method of lithium cobalt pyrophosphate according to the first embodiment.

FIG. 2 is a diagram showing an example of the production method of lithium cobalt pyrophosphate according to the first embodiment.

FIG. 3 is a diagram illustrating the production method of lithium cobalt pyrophosphate according to the second embodiment.

FIG. 4 is a diagram showing an example of the production method of lithium cobalt pyrophosphate according to the second embodiment.

FIG. 5 is a diagram showing a configuration example of the solid-state battery.

FIG. 6 is a diagram (first part) illustrating the first formation example of the solid-state battery body.

FIG. 7 is a diagram (second part) illustrating the first formation example of the solid-state battery body.

FIG. 8 is a diagram (first part) illustrating the second formation example of the solid-state battery body.

FIG. 9 is a diagram (second part) illustrating the second formation example of the solid-state battery body.

FIG. 10 is a diagram (first part) illustrating the third formation example of the solid-state battery body.

FIG. 11 is a diagram (second part) illustrating the third formation example of the solid-state battery body.

FIG. 12 is a diagram illustrating firing of the basic structure of the solid-state battery body.

FIG. 13 is a diagram showing another configuration example of the solid-state battery.

FIG. 14 is a diagram showing yet another configuration example of the solid-state battery.

### DESCRIPTION OF EMBODIMENTS

### First Embodiment

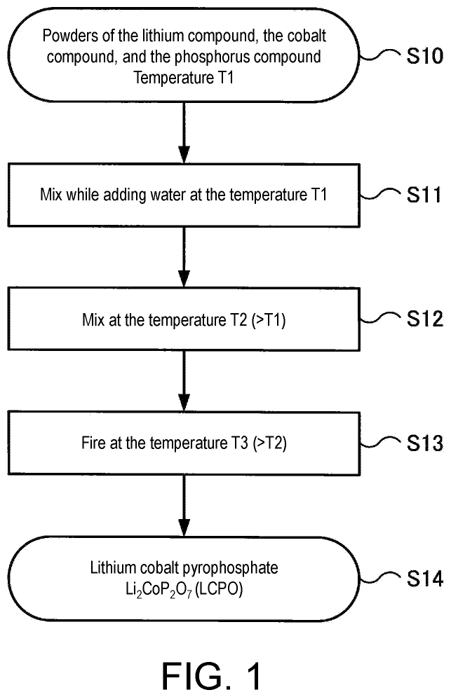

FIG. 1 is a diagram illustrating the production method of lithium cobalt pyrophosphate according to the first embodiment.

In the production method of lithium cobalt pyrophosphate (Li₂CoP₂O₇, hereinafter also referred to as “LCPO”) shown in FIG. 1, first, powders of a lithium (Li) compound, a cobalt (Co) compound, and a phosphorus (P) compound in amounts based on the composition thereof are prepared at a predetermined temperature T1 (step S10).

In step S10, the Li compound is a substance that serves as a Li raw material of LCPO. The Co compound is a substance that serves as a Co raw material of LCPO. The P compound is a substance that serves as a P raw material of LCPO. The powders of the Li compound, the Co compound, and the P compound are weighed and prepared so that the material to be obtained by firing in step S13, which will be described later, has the composition of LCPO, that is, Li₂CoP₂O₇. The temperature T1 at which the powders of the Li compound, the Co compound, and the P compound are prepared is a temperature below 40° C., for example, room temperature.

The powders of the Li compound, the Co compound, and the P compound prepared at the temperature T1 are mixed while water is added at the temperature T1 (step S11).

In step S11, the amount of water to be added is set to a constant ratio with respect to the total weight of the powders of the Li compound, the Co compound, and the P compound and, for example, the total weight of water to be contained in the mixed material of the Li compound, the Co compound, and the P compound by addition is set to 2.0 wt % to 38.3 wt % of the total weight of the powders before addition. Pure water can be used as the water to be added to the powders of the Li compound, the Co compound, and the P compound. It is not necessary to contain other substances such as citric acid in the water to be added.

In step S11, water is gradually added to the powders of the Li compound, the Co compound, and the P compound to be mixed. For example, a method of adding water little by little while mixing the powders of the Li compound, the Co compound, and the P compound is used. Alternatively, a method of alternately repeating mixing the powders of the Li compound, the Co compound, and the P compound and adding a small amount of water may be used. Water can be added by, for example, a method of dropping or spraying water onto the powders of the Li compound, the Co compound, and the P compound to be mixed. After addition of water, the powders may be further mixed at the temperature T1. For example, the material obtained in step S11 is a powder.

The material obtained by adding water to and mixing the powders of the Li compound, the Co compound, and the P compound at the temperature T1 (step S11) is heated to a temperature T2 higher than the temperature T1 and further mixed at the temperature T2 (step S12). In step S12, the temperature T2 is set to a range of 40° C. to 60° C., for example. For example, the material obtained in step S12 is a powder.

By the above step S11 and step S12, the material containing a precursor for LCPO, for example, the material containing lithium phosphate (Li₃PO₄) and ammonium cobalt phosphate (NH₄CoPO₄) as described later, is produced.

The material obtained by adding water and mixing at the temperature T1 (step S11) and mixing at the higher temperature T2 (step S12), that is, the material containing the precursor for LCPO, is fired at a temperature T3 higher than the temperature T2 (step S13). In step S13, the temperature T3 is set to a range of 650° C. to 690° C., for example.

LCPO is obtained (step S14) by such firing at the temperature T3 (step S13).

Thus, in the production method of LCPO shown in FIG. 1, the Li raw material, the Co raw material, and the P raw material are reacted in the presence of water while being mixed at the temperature T1 (step S11) and heated and mixed at the higher temperature T2 (step S12). As a result, a precursor for LCPO having excellent uniformity of distribution of the Li component, the Co component, and the P component is formed. By forming such a precursor for LCPO having excellent uniformity of each component, it is possible to obtain LCPO in which the generation of different phases is suppressed by firing (step S13).

The production method of LCPO as described above will be described more specifically.

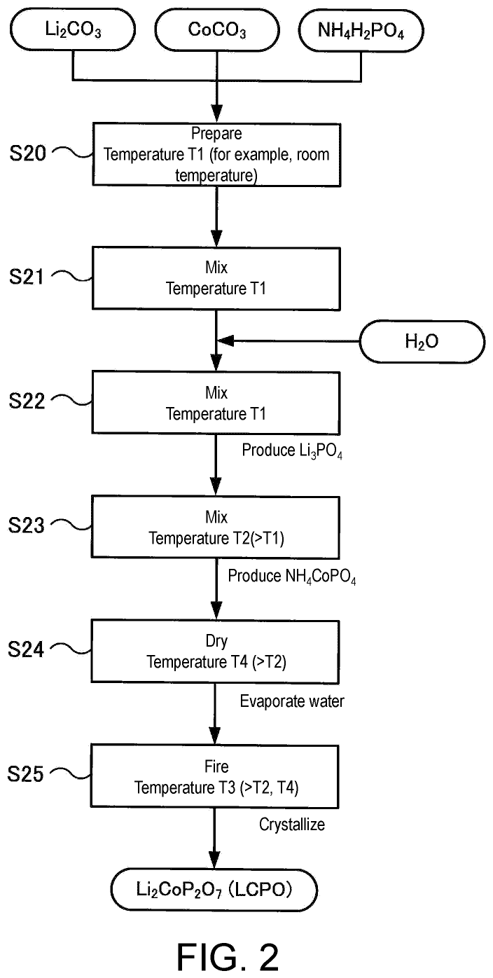

FIG. 2 is a diagram showing an example of the production method of lithium cobalt pyrophosphate according to the first embodiment.

First, powders of the Li raw material, the Co raw material, and the P raw material in amounts based on the composition of LCPO are prepared at the temperature T1 (step S20). Lithium carbonate (Li₂CO₃), for example, is used as the powder of the Li raw material. Cobalt carbonate (CoCO₃) or basic cobalt carbonate (xCoCO₃·yCo(OH)₂·zH₂O), for example, is used as the powder of the Co raw material. Ammonium dihydrogen phosphate (NH₄H₂PO₄), for example, is used as the powder of the P raw material. These powders of Li₂CO₃, CoCO₃, and NH₄H₂PO₄ are weighed and prepared so as to form the composition of LCPO, that is, Li₂CoP₂O₇, to be obtained by firing in step S25 described later. For example, 150.5 g of Li₂CO₃ powder, 250.3 g of basic CoCO3 powder, and 469.5 g of NH₄H₂PO₄ powder are weighed and prepared respectively. The temperature T1 at which these powders are prepared is a temperature below 40° C., for example, room temperature.

The prepared powders of Li₂CO₃, basic CoCO₃, and NH₄H₂PO₄ are mixed at the temperature T1 (step S21). For example, the powders of Li₂CO₃, basic CoCO₃, and NH₄H₂PO₄ are mixed at the temperature T1 for 10 minutes. This step S21, in which the powders of Li₂CO₃, basic CoCO₃, and NH₄H₂PO₄ are mixed at the temperature T1, can also be said to be a form of preparation of the powders of the Li raw material, the Co raw material, and the P raw material at the temperature T1.

The powders of Li₂CO₃, basic CoCO₃, and NH₄H₂PO₄ mixed (or prepared) at the temperature T1 (step S21) are mixed while a certain amount of water (H₂O) is added at the temperature T1 (step S22). The amount of water added is, for example, set so that the total weight of water to be contained in the mixed material of Li₂CO₃, basic CoCO₃, and NH₄H₂PO₄ by addition is 2.0 wt % to 38.3 wt % of the total weight of the powders before addition. As an example, 17 cc to 180 cc of water is added. For example, a method of adding 125 cc of water over 15 minutes while mixing the powders of Li₂CO₃, basic CoCO₃, and NH₄H₂PO₄ at the temperature T1 is used. In step S22, the material obtained by adding a certain amount of water and mixing at the temperature T1 may be further mixed at the temperature T1 after the certain amount of water is added. For example, after a certain amount of water is added, mixing is further performed at the temperature T1 for 15 minutes. For example, the material obtained in step S22 is a powder. By this step S22, a precursor for LCPO, mainly Li₃PO₄, is produced.

In the production method of LCPO shown in FIG. 2, the material containing Li₃PO₄ that is the precursor for LCPO is formed by the processes up to step S22.

The material obtained by adding a certain amount of water to the powders of Li₂CO₃, basic CoCO₃, and NH₄H₂PO₄ and mixing at the temperature T1 (step S22), that is, the material containing the precursor for LCPO (mainly Li₃PO₄), is heated to the temperature T2, which is higher than the temperature T1, and further mixed at the temperature T2 (step S23). The temperature T2 is set to a range of 40° C. to 60° C., for example. For example, the material obtained by adding a certain amount of water and mixing at the temperature T1 is heated to the temperature T2=50° C. and further mixed at the temperature T2 for 15 minutes. For example, the material obtained in step S23 is a powder. By this step S23, a precursor for LCPO, mainly NH₄CoPO₄, is produced.

In the production method of LCPO shown in FIG. 2, the material containing Li₃PO₄ and NH₄CoPO₄ that are the precursor for LCPO is formed by the processes up to step S23.

The material obtained by mixing at the temperature T2 (step S23), that is, the material containing Li₃PO₄ and NH₄CoPO₄ that are the precursor for LCPO, is dried at a temperature T4, which is higher than the temperature T2 (step S24). The temperature T4 is set to 90° C., for example. For example, the material obtained by mixing at the temperature T2 is heated to the temperature T4=90° C., and drying is completed when the temperature reaches 90° C. By performing such drying, the water in the material is evaporated and removed.

The material obtained by drying (step S24) is placed in a heat-resistant container such as a sagger and fired at the temperature T3, which is higher than the temperature T4 (and the temperature T2) (step S25). The temperature T3 is set to a range of 650° C. to 690° C., for example. Firing is performed in an air atmosphere or a non-oxidizing atmosphere. For example, the material obtained by drying is fired at 680° C. for 10 hours in an air atmosphere. The material obtained by drying is crystallized by firing to obtain LCPO. In this example, 500 g of LCPO is obtained from 150.5 g of Li₂CO₃, 250.3 g of basic CoCO₃, and 469.5 g of NH₄H₂PO₄ which are the raw materials.

In the production method of LCPO shown in FIG. 2, after the Li raw material, the Co raw material, and the P raw material are mixed at the temperature T1 (step S21), mixing at the temperature T1 (step S22) and heating and mixing at the higher temperature T2 (step S23) are performed in the presence of water to react the Li raw material, the Co raw material, and the P raw material. As a result, a precursor for LCPO having excellent uniformity of distribution of the Li component, the Co component, and the P component is formed.

For example, when Li₂CO₃, CoCO₃, and NH₄H₂PO₄ as described above are used as the Li raw material, the Co raw material, and the P raw material, respectively, in the production method of LCPO shown in FIG. 2, the reaction as shown in the following formula (1) proceeds.

Li₂CO₃+CoCO₃+2NH₄H₂PO₄→2/3Li₃PO₄+NH₄CoPO₄+1/3NH₄H₂PO₄+2CO₂+2/3NH₃+2H₂O (1)

Here, the water-soluble P raw material NH₄H₂PO₄ is dissolved in water, and the dissolved NH₄H₂PO₄ reacts with the Li raw material Li₂CO₃ and the Co raw material CoCO₃ as shown in formula (1) to produce Li₃PO₄ and NH₄CoPO₄ that are the precursor for LCPO. In the production method of LCPO shown in FIG. 2, mainly Li₃PO₄ is produced in step S22 in which the Li raw material Li₂CO₃, the Co raw material CoCO₃, and the P raw material NH₄H₂PO₄ are mixed at the temperature T1 while a certain amount of water is added, and mainly NH₄CoPO₄ is produced in step S23 in which the raw materials are mixed at the higher temperature T2. Further, carbon dioxide (CO₂) gas is generated in steps S22 and S23, for example, and ammonia (NH₃) gas is generated in steps S23 to S25, for example.

By the reaction as shown in formula (1), which proceeds with the mixing and heating of the Li raw material Li₂CO₃ and the Co raw material CoCO₃ in the presence of a certain amount of water (steps S22 and S23), the produced Li₃PO₄ and NH₄CoPO₄ are uniformly dispersed and mixed at the atomic level within the material. The P raw material NH₄H₂PO₄ remains an unreacted portion that does not react with the Li raw material Li₂CO₃ and the Co raw material CoCO₃, but since it is dissolved in water once, it is also uniformly dispersed in the material with the mixing. As a result, Li₃PO₄ and NH₄CoPO₄ as well as NH₄H₂PO₄ are properly mixed and dispersed, and a precursor for LCPO having excellent uniformity of distribution of the Li component, the Co component, and the P component is formed.

In the production method of LCPO shown in FIG. 2, by forming such a precursor for LCPO that has excellent uniformity of distribution of the Li component, the Co component, and the P component, LCPO in which the generation of different phases is suppressed is obtained by firing at the higher temperature T3 (step S25) after drying at the temperature T4 (step S24).

Further, in the production method of LCPO shown in FIG. 2, the amount of water added in step S22 is set so that the total weight of water to be contained in the mixed powder of the Li raw material, the Co raw material, and the P raw material by addition is 2.0 wt % to 38.3 wt %, preferably 26.6 wt %, of the total weight of the powder before addition. If the amount of water is less than 2.0 wt %, dissolution of the P raw material tends to be insufficient, and if the amount of water exceeds 38.3 wt %, the drying time in step S24 becomes longer, and lumps are more likely to occur.

In the production method of LCPO shown in FIG. 2, the temperature T2 during the mixing in step S23 is set to 40° C. to 60° C., preferably 50° C. If the temperature T2 is lower than 40° C., NH₄CoPO₄ may not be produced sufficiently, and if the temperature T2 is higher than 60° C., water may evaporate too much, and the reaction tends to be uneven.

In the production method of LCPO shown in FIG. 2, the temperature T3 during the firing in step S25 is set to 650° C. to 690° C., preferably 680° C. If the temperature T3 is lower than 650° C., different phases other than LCPO are likely to occur, and if the temperature T3 is higher than 690° C., the material to be fired may melt, and different phases other than LCPO are likely to occur.

Different phases other than LCPO tend to be generated when the Li component, the Co component, and the P component contained in the precursor for LCPO before firing are not uniformly distributed. That is, if the precursor for LCPO that does not have a uniform distribution of the Li component, the Co component, and the P component is fired, different phases tend to be generated. In order to increase the uniformity of distribution of each component, the Li raw material, the Co raw material, and the P raw material are mixed for a long time or pulverized, but even so, it may be difficult to obtain LCPO in which the generation of different phases is suppressed. Besides, the time and cost for obtaining LCPO in which the generation of different phases is suppressed may increase.

In contrast, according to the production method of LCPO shown in FIG. 2, it is possible to form a precursor for LCPO having excellent uniformity of distribution of the Li component, the Co component, and the P component in a relatively short time while suppressing an increase in cost, and it is possible to obtain LCPO in which the generation of different phases is suppressed by the firing.

### Second embodiment

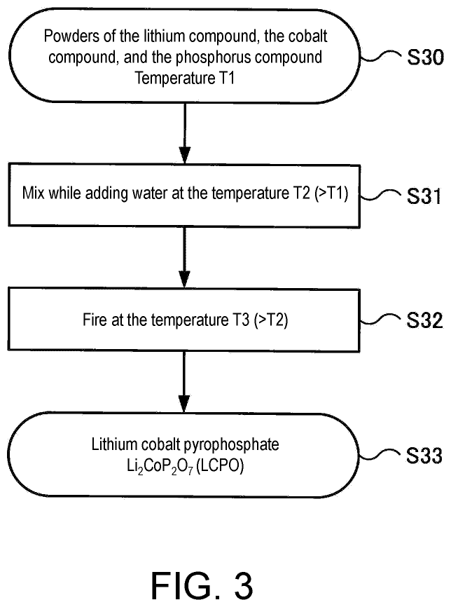

FIG. 3 is a diagram illustrating the production method of lithium cobalt pyrophosphate according to the second embodiment.

In the production method of LCPO shown in FIG. 3, first, powders of a Li compound, a Co compound, and a P compound in amounts based on the composition of LCPO are prepared at a predetermined temperature T1 (step S30).

In step S30, the Li compound is a substance that serves as a Li raw material of LCPO. The Co compound is a substance that serves as a Co raw material of LCPO. The P compound is a substance that serves as a P raw material of LCPO. The powders of the Li compound, the Co compound, and the P compound are weighed and prepared so as to form the composition of LCPO, that is, Li₂CoP₂O₇, to be obtained by firing in step S32 described later. The temperature T1 at which the powders of the Li compound, the Co compound, and the P compound are prepared is a temperature below 40° C., for example, room temperature.

The powders of the Li compound, the Co compound, and the P compound prepared at the temperature T1 are heated to a temperature T2, which is higher than the temperature T1, and mixed while water is added at the temperature T2 (step S31).

In step S31, the temperature T2 is set to a range of 40° C. to 60° C., for example.

In step S31, the amount of water to be added is set to a constant ratio with respect to the total weight of the powders of the Li compound, the Co compound, and the P compound. For example, the total weight of water to be contained in the mixed material of the Li compound, the Co compound, and the P compound by addition is set to 14.9 wt % to 95.8 wt % of the total weight of the powders before addition. Pure water can be used as the water to be added to the powders of the Li compound, the Co compound, and the P compound. It is not necessary to contain other substances such as citric acid in the water to be added.

In step S31, water is gradually added to the powders of the Li compound, the Co compound, and the P compound to be mixed. For example, a method of adding water little by little while mixing powders of the Li compound, the Co compound, and the P compound is used. Alternatively, a method of alternately repeating mixing the powders of the Li compound, the Co compound, and the P compound and adding a small amount of water may be used. Water can be added by, for example, dropping or spraying water onto the powders of the Li compound, the Co compound, and the P compound to be mixed. For example, the material obtained in step S31 is a powder.

By step S31, a material containing a precursor for LCPO, for example, a material containing Li₃PO₄ and NH₄CoPO₄ is produced.

The material obtained by adding water and mixing at the temperature T2 (step S31), that is, the material containing the precursor for LCPO, is fired at a temperature T3 higher than the temperature T2 (step S32). In step S32, the temperature T3 is set to a range of 650° C. to 690° C., for example.

LCPO is obtained (step S33) by such firing at the temperature T3 (step S32).

In the production method of LCPO shown in FIG. 3, the Li raw material, the Co raw material, and the P raw material are reacted in the presence of water while being mixed at the temperature T2 higher than the temperature T1 (step S31). As a result, a precursor for LCPO having excellent uniformity of distribution of the Li component, the Co component, and the P component is formed. By forming such a precursor for LCPO having excellent uniformity of each component, it is possible to obtain LCPO in which the generation of different phases is suppressed by firing (step S32).

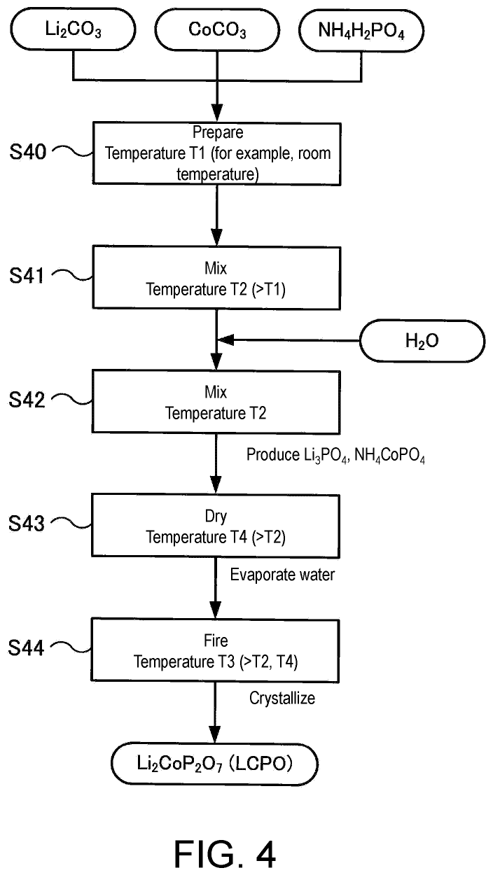

The production method of LCPO as described above will be described more specifically. FIG. 4 is a diagram showing an example of the production method of lithium cobalt pyrophosphate according to the second embodiment.

First, powders of the Li raw material, the Co raw material, and the P raw material in amounts based on the composition of LCPO are prepared at the temperature T1 (step S40). Li₂CO₃, for example, is used as the powder of the Li raw material. CoCO₃ or basic CoCO₃, for example, is used as the powder of the Co raw material. NH₄H₂PO₄, for example, is used as the powder of the P raw material. These powders of Li₂CO₃, CoCO₃, and NH₄H₂PO₄ are weighed and prepared so as to form the composition of LCPO, that is, Li₂CoP₂O₇, to be obtained by firing in step S44 described later. For example, 150.5 g of Li₂CO₃ powder, 250.3 g of basic CoCO₃ powder, and 469.5 g of NH₄H₂PO₄ powder are weighed and prepared respectively. The temperature T1 at which these powders are prepared is a temperature below 40° C., for example, room temperature.

The prepared powders of Li₂CO₃, basic CoCO₃, and NH₄H₂PO₄ are heated to the temperature T2 higher than the temperature T1 and mixed (step S41). The powders of Li₂CO₃, basic CoCO₃, and NH₄H₂PO₄ may be mixed while being heated up to the temperature T2 or mixed after being heated up to the temperature T2.

Then, the powders of Li₂CO₃, basic CoCO₃, and NH₄H₂PO₄ heated to the temperature T2 are mixed while a certain amount of water (H₂O) is added at the temperature T2 (step S42). The amount of water added is, for example, set so that the total weight of water to be contained in the mixed material of Li₂CO₃, basic CoCO₃, and NH₄H₂PO₄ by addition is 14.9 wt % to 95.8 wt % of the total weight of the powders before addition. As an example, 70 cc to 450 cc of water is added. For example, a method of mixing the powders of Li₂CO₃, basic CoCO₃, and NH₄H₂PO₄ for 15 minutes while spraying 300 cc of water at the temperature T2 is used. For example, the material obtained in step S42 is a powder. By this step S42, Li₃PO₄ and NH₄CoPO₄ that are a precursor for LCPO are both produced.

In the production method of LCPO shown in FIG. 4, the material containing Li₃PO₄ and NH₄CoPO₄ that are the precursor for LCPO is formed by the processes up to step S42.

The material obtained by adding a certain amount of water and mixing at the temperature T2 (step S42), that is, the material containing Li₃PO₄ and NH₄CoPO₄ that are the precursor for LCPO, is dried at a temperature T4, which is higher than the temperature T2 (step S43). The temperature T4 is set to 90° C., for example. For example, the material obtained by adding a certain amount of water and mixing at the temperature T2 is heated to the temperature T4=90° C., and drying is completed when the temperature reaches 90° C. By performing such drying, the water in the material is evaporated and removed.

The material obtained by drying (step S43) is placed in a heat-resistant container such as a sagger and fired at a temperature T3, which is higher than the temperature T4 (and the temperature T2) (step S44). The temperature T3 is set to a range of 650° C. to 690° C., for example. Firing is performed, for example, in an air atmosphere or a non-oxidizing atmosphere. For example, the material obtained by drying is fired at 680° C. for 10 hours in an air atmosphere. The material obtained by drying is crystallized by firing to obtain LCPO. In this example, 500 g of LCPO is obtained from 150.5 g of Li₂CO₃, 250.3 g of basic CoCO₃, and 469.5 g of NH₄H₂PO₄ which are the raw materials.

In the production method of LCPO shown in FIG. 4, the Li raw material, the Co raw material, and the P raw material are mixed in the presence of water at the temperature T2 higher than the temperature T1 (step S42) to react. As a result, a precursor for LCPO having excellent uniformity of distribution of the Li component, the Co component, and the P component is formed.

For example, when Li₂CO₃, CoCO₃, and NH₄H₂PO₄ as described above are used as the Li raw material, the Co raw material, and the P raw material, respectively, in the production method of LCPO shown in FIG. 4, the reaction as shown in the above formula (1) proceeds. The water-soluble P raw material NH₄H₂PO₄ is dissolved in water, and the dissolved NH₄H₂PO₄ reacts with the Li raw material Li₂CO₃ and the Co raw material CoCO₃ as shown in formula (1) to produce Li₃PO₄ and NH₄CoPO₄ that are the precursor for LCPO. In the production method of LCPO shown in FIG. 4, both Li₃PO₄ and NH₄CoPO₄ are produced in step S42 in which the Li raw material Li₂CO₃, the Co raw material CoCO₃, and the P raw material NH₄H₂PO₄ are mixed while a certain amount of water is added at the temperature T2. Further, CO₂ gas is generated in step S42, for example, and NH₃ gas is generated in steps S42 to S44, for example.

By the reaction as shown in formula (1), which proceeds with the addition of a certain amount of water to the heated Li raw material Li₂CO₃ and Co raw material CoCO₃ and the mixing of these (step S42), the produced Li₃PO₄ and NH₄CoPO₄ are uniformly dispersed and mixed at the atomic level within the material. The P raw material NH₄H₂PO₄ remains an unreacted portion, but since it is dissolved in water once, it is uniformly dispersed in the material with the mixing. As a result, Li₃PO₄ and NH₄CoPO₄ as well as NH₄H₂PO₄ are properly mixed and dispersed, and a precursor for LCPO having excellent uniformity of distribution of the Li component, the Co component, and the P component is formed.

In the production method of LCPO shown in FIG. 4, by forming such a precursor for LCPO that has excellent uniformity of distribution of the Li component, the Co component, and the P component, LCPO in which the generation of different phases is suppressed is obtained by firing at the higher temperature T3 (step S44) after drying at the temperature T4 (step S43).

Further, in the production of LCPO shown in FIG. 4, the amount of water added in step S42 is set so that the total weight of water to be contained in the mixed material of the Li raw material, the Co raw material, and the P raw material by addition is 14.9 wt % to 95.8 wt %, preferably 63.9 wt %, of the total weight of the powder before addition. If the amount of water is less than 14.9 wt %, dissolution of the P raw material tends to be insufficient, and if the amount of water exceeds 95.8 wt %, the drying time in step S43 becomes longer, and lumps are more likely to occur.

In the production of LCPO shown in FIG. 4, the temperature T2 during the mixing in step S42 is set to 40° C. to 60° C., preferably 50° C. If the temperature T2 is lower than 40° C., NH₄CoPO₄ may not be produced sufficiently, and if the temperature T2 is higher than 60° C., water may evaporate too much, and the reaction tends to be uneven.

In the production of LCPO shown in FIG. 4, the temperature T3 during the firing in step S44 is set to 650° C. to 690° C., preferably 680° C. If the temperature T3 is lower than 650° C., different phases other than LCPO are likely to occur, and if the temperature T3 is higher than 690° C., the material to be fired may melt, and different phases other than LCPO are likely to occur.

According to the production method of LCPO shown in FIG. 4, it is possible to form a precursor for LCPO having excellent uniformity of distribution of the Li component, the Co component, and the P component in a relatively short time while suppressing an increase in cost, and it is possible to obtain LCPO in which the generation of different phases is suppressed by the firing.

The first and second embodiments illustrate above the production method of LCPO in which the generation of different phases can be suppressed.

Further, the above description illustrates an example in which Li₂CO₃ is used as the Li raw material, CoCO₃ or basic CoCO₃ is used as the Co raw material, and NH₄H₂PO₄ is used as the P raw material, but other materials can also be used as the Li raw material, the Co raw material, and the P raw material. For example, lithium nitrate (LiNO3), lithium hydroxide (LiOH), etc. can also be used as the Li raw material. Cobalt nitrate (Co(NO₃)₂ or Co(NO₃)₂·6H₂O), cobalt hydroxide (Co(OH)₂), cobalt oxide (CoO, Co₃O₄), etc. can also be used as the Co raw material. Ammonium monohydrogen phosphate ((NH₄)₂HPO₄), phosphoric acid (H₃PO₄), etc. can also be used as the P raw material.

Further, the combination of Li₂CO₃ and CoCO₃ as shown in the above example is advantageous in that side reactions (oxidation of the Co raw material due to oxygen in the air) are easily suppressed. In addition, since (NH₄)₂HPO₄ generates more NH₃ gas than NH₄H₂PO₄, H₃PO₄ accelerates the dissolution reaction of the Li raw material and the Co raw material, and aggregation and solidification may occur depending on the conditions, from these viewpoints, it is advantageous to use NH₄H₂PO₄ as shown in the above example.

By the way, LCPO is considered to be used as a positive electrode active material in the field of batteries.

As one of the batteries, a solid-state battery is known, which includes a positive electrode layer containing a positive electrode active material, a solid electrolyte, etc.; a negative electrode layer containing a negative electrode active material, a solid electrolyte, etc.; and a layer of a solid electrolyte provided between the positive electrode layer and the negative electrode layer. Unlike a lithium-ion secondary battery, the solid-state battery does not use a flammable organic electrolyte, so the solid-state battery has advantages that it can reduce the risks of liquid leakage, combustion, explosion, and toxic gas generation and improve safety, it is easy to handle in the atmosphere, and it can maintain the performance even under conditions of low and high temperatures.

LCPO is used, for example, as the positive electrode active material contained in the positive electrode layer of such a solid-state battery. Since LCPO has a relatively high voltage when operating as the positive electrode, LCPO is one of the effective materials for widening the voltage difference when the active material on the negative electrode layer side operates as the negative electrode to realize a battery cell with a high operating voltage.

An example of a solid-state battery using LCPO as the positive electrode active material will be described hereinafter as the third embodiment.

### Third Embodiment

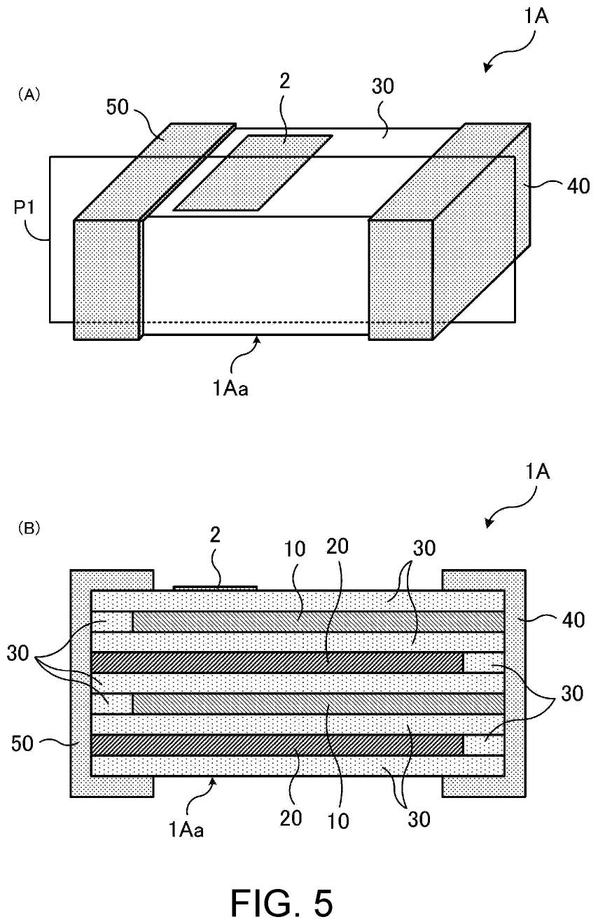

FIG. 5 is a diagram showing a configuration example of the solid-state battery. (A) of FIG. 5 schematically shows an external perspective view of an example of the solid-state battery. (B) of FIG. 5 schematically shows a cross-sectional view of main parts of an example of the solid-state battery. (B) of FIG. 5 is an example of a cut surface along the plane P1 in (A) of FIG. 5.

The solid-state battery lA shown in (A) of FIG. 5 and (B) of FIG. 5 is an example of a chip-type battery. The solid-state battery lA has a solid-state battery body 1Aa, and a current collector 40 (electrode) and a current collector 50 (electrode) respectively provided at both ends of the solid-state battery body 1Aa.

As shown in (B) of FIG. 5, the solid-state battery body 1Aa has a structure in which electrolyte layers 30, positive electrode layers 10, and negative electrode layers 20 are laminated. One layer of electrolyte layer 30 is interposed between a set of positive electrode layer 10 and negative electrode layer 20, and one layer of electrolyte layer 30 is provided above the uppermost positive electrode layer 10 and below the lowermost negative electrode layer 20, respectively. The positive electrode layer 10 is connected to the current collector 40 provided at one end of the solid-state battery body 1Aa, and the negative electrode layer 20 is connected to the current collector 50 provided at the other end of the solid-state battery body 1Aa. A side surface of the positive electrode layer 10 is surrounded by, for example, the electrolyte layer 30 provided in the same layer as the positive electrode layer 10 except for the portion connected with the current collector 40, and a side surface of the negative electrode layer 20 is surrounded by, for example, the electrolyte layer 30 provided in the same layer as the negative electrode layer 20 except for the portion connected with the current collector 50. As shown in (A) and (B) of FIG. 5, for example, the group of laminated electrolyte layers 30 (oxide solid electrolytes thereof) is exposed on the outer surface of the solid-state battery body 1Aa.

As shown in (A) and (B) of FIG. 5, the electrolyte layer 30 on the outermost surface of the solid-state battery body 1Aa is provided with a polarity marker 2 that indicates which of the current collectors 40 and 50 is on the positive electrode side and which is on the negative electrode side. The polarity marker 2 provided in this example indicates that the current collector 50 connected to the negative electrode layer 20 is on the negative electrode side.

The electrolyte layer 30 of the solid-state battery body 1Aa contains a solid electrolyte material. An oxide solid electrolyte is used as the solid electrolyte material of the electrolyte layer 30. For example, LAGP, which is a type of NASICON (Na super ionic conductor) type (also referred to as “Nasicon type”) oxide solid electrolyte, is used as the electrolyte layer 30. LAGP is an oxide solid electrolyte represented by the general formula Li₁₊ₛAlₛGe₂₋ₛ(PO₄)₃(0<s≤1), and is called aluminum-substituted lithium germanium phosphate or the like. In this example, Li_{1.5}Al_{0.5}Ge_{1.5}(PO₄)₃ with a composition ratio of s=0.5 is used as the LAGP of the electrolyte layer 30.

The positive electrode layer 10 of the solid-state battery body 1Aa contains a solid electrolyte material, a conductive aid, and a positive electrode active material. An oxide solid electrolyte is used as the solid electrolyte material of the positive electrode layer 10. For example, the same material as the oxide solid electrolyte, used as the electrolyte layer 30, is used as the oxide solid electrolyte of the positive electrode layer 10. That is, in this example, LAGP is used as the oxide solid electrolyte of the positive electrode layer 10. For example, a carbon material such as carbon fiber, carbon black, graphite, graphene, and carbon nanotube is used as the conductive aid of the positive electrode layer 10. In addition, a metal material, a metal silicide material such as nickel silicide and iron silicide, a conductive polymer material, or the like may be used as the conductive aid. LCPO obtained by the production method as described in the above first or second embodiment is used as the positive electrode active material of the positive electrode layer 10. LCPO has a voltage of about 5 V (Li/Li⁺) when operating as the positive electrode. In addition to LCPO, the positive electrode active material of the positive electrode layer 10 may also include other positive electrode active materials such as lithium cobalt phosphate (LiCoPO₄) and lithium vanadium phosphate (Li₃V₂(PO₄)₃, hereinafter referred to as “LVP”).

The negative electrode layer 20 of the solid-state battery body 1Aa contains a solid electrolyte material, a conductive aid, and a negative electrode active material. An oxide solid electrolyte is used as the solid electrolyte material of the negative electrode layer 20. For example, the same material as the oxide solid electrolyte, used as the electrolyte layer 30, is used as the oxide solid electrolyte of the negative electrode layer 20. That is, in this example, LAGP is used as the oxide solid electrolyte of the negative electrode layer 20. For example, a carbon material such as carbon fiber, carbon black, graphite, graphene, and carbon nanotube is used as the conductive aid of the negative electrode layer 20. In addition, a metal material, a metal silicide material such as nickel silicide and iron silicide, a conductive polymer material, or the like may be used as the conductive aid. LVP, lithium titanate (Li₄Ti₅O₁₂), titanium oxide (TiO₂), niobium oxide (Nb₂O₅), or the like is used as the negative electrode active material of the negative electrode layer 20. In addition, NASICON type LATP (general formula Li₁₊ₜAlₜTi₂₋ₜ(PO₄)₃, 0<t≤1), a metal silicide material such as nickel silicide and iron silicide, or the like may also be used as the negative electrode active material of the negative electrode layer 20. In the negative electrode layer 20, one type of material or two or more types of materials may be used as the negative electrode active material.

When the solid-state battery 1A is charged, lithium ions are conducted and taken in from the positive electrode layer 10 to the negative electrode layer 20 via the electrolyte layer 30, and when the solid-state battery 1A is discharged, lithium ions are conducted and taken in from the negative electrode layer 20 to the positive electrode layer 10 via the electrolyte layer 30. In the solid-state battery 1A, the charging and discharging operations are realized by such lithium ion conduction.

A production method of the solid-state battery 1A having the configuration as shown in (A) and (B) of FIG. 5 will be described hereinafter.

(LAGP Powder)

First, powders of Li₂CO₃, aluminum oxide (Al₂O₃), germanium oxide (GeO₂), and NH₄H₂PO₄, which are raw materials of LAGP, are weighed and mixed so as to form a predetermined composition ratio. The mixture obtained by mixing is temporarily fired at a temperature of 300° C. to 400° C. for 3 hours to 5 hours. The powder obtained by temporarily firing is melted by a heat treatment at a temperature of 1200° C. to 1400° C. for 1 hour to 2 hours. The material obtained by melting is quenched and vitrified. As a result, an amorphous LAGP powder is obtained.

The obtained LAGP powder is pulverized and adjusted to a target particle size p (median size D50). Here, the particle size p of the LAGP powder for the electrolyte layer is adjusted to, for example, 2 μm≤p≤5 μm. In addition, regarding the LAGP powder for the positive electrode layer and the negative electrode layer (each also referred to as “electrode layer”), from the viewpoint of ensuring the lithium ion conductivity of the electrode layer by interposing the LAGP powder between the particles of the powdery active material, the particle size p is finer than that for the electrolyte layer and is adjusted to, for example, 0.2 μm≤p≤1.0 μm.

For example, by such a method, the LAGP powder to be used for the electrolyte layer 30, the positive electrode layer 10, and the negative electrode layer 20 of the solid-state battery 1A as shown in (B) of FIG. 5 is prepared.

(Electrolyte Layer)

As an example, the LAGP powder having the particle size p for the electrolyte layer obtained by the above method is mixed with an organic binder, a solvent, etc. and coated on a carrier such as a polyethylene terephthalate (PET) film by a doctor blade method or the like to form a flexible electrolyte layer green sheet (also referred to as “LAGP green sheet”). For example, the electrolyte layer green sheet formed in this manner is used to form the electrolyte layer 30 as shown in (B) of FIG. 5.

Further, as another example, the LAGP powder having the particle size p for the electrolyte layer obtained by the above method is formed into a green compact by a uniaxial hydraulic press and fired at the temperature of 900° C. for 3 hours. As a result, an electrolyte layer substrate (also referred to as “LAGP substrate”) is formed. For example, the electrolyte layer substrate formed in this manner is used to form the electrolyte layer 30 as shown in (B) of FIG. 5.

(Positive Electrode Layer and Negative Electrode Layer)

As an example, the LAGP powder having the particle size p for the electrode layer obtained by the above method is mixed with a conductive aid, a positive electrode active material containing at least LCPO, a binder such as an acrylic resin, a solvent, etc. and coated on a carrier such as a PET film by a doctor blade method or the like to form a positive electrode layer green sheet. The LAGP powder having the particle size p for the electrode layer obtained by the above method is mixed with a conductive aid, a negative electrode active material, a binder such as an acrylic resin, a solvent, etc. and coated on a carrier such as a PET film by a doctor blade method or the like to form a negative electrode layer green sheet. For example, the positive electrode layer green sheet and the negative electrode layer green sheet formed in this manner are used to form the positive electrode layer 10 and the negative electrode layer 20 as shown in (B) of FIG. 5, respectively.

Further, as another example, the LAGP powder having the particle size p for the electrode layer obtained by the above method is mixed with a conductive aid, a positive electrode active material containing at least LCPO, a binder such as an acrylic resin, a solvent, etc. to form a positive electrode layer paste. The LAGP powder having the particle size p for the electrode layer obtained by the above method is mixed with a conductive aid, a negative electrode active material, a binder such as an acrylic resin, a solvent, etc. to form a negative electrode layer paste. For example, the positive electrode layer paste and the negative electrode layer paste formed in this manner are used to form the positive electrode layer 10 and the negative electrode layer 20 as shown in (B) of FIG. 5, respectively.

(Solid-State Battery Body)

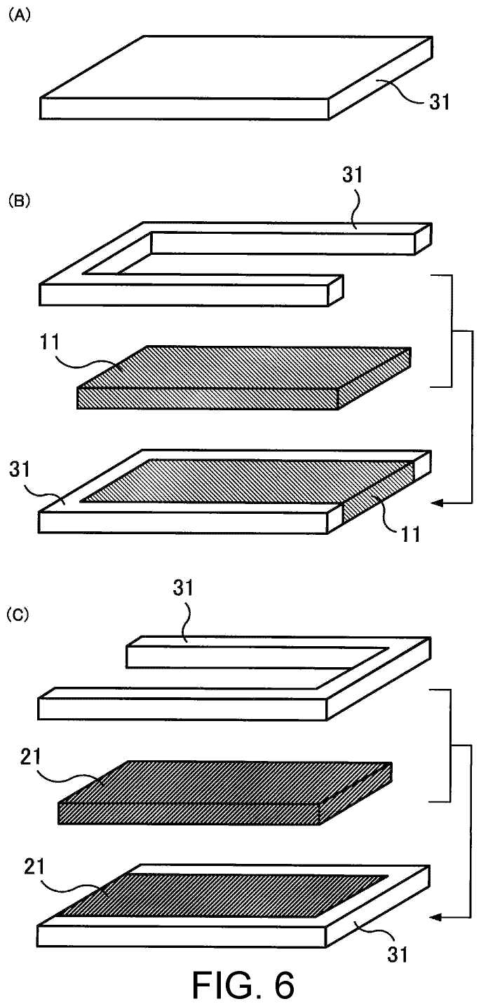

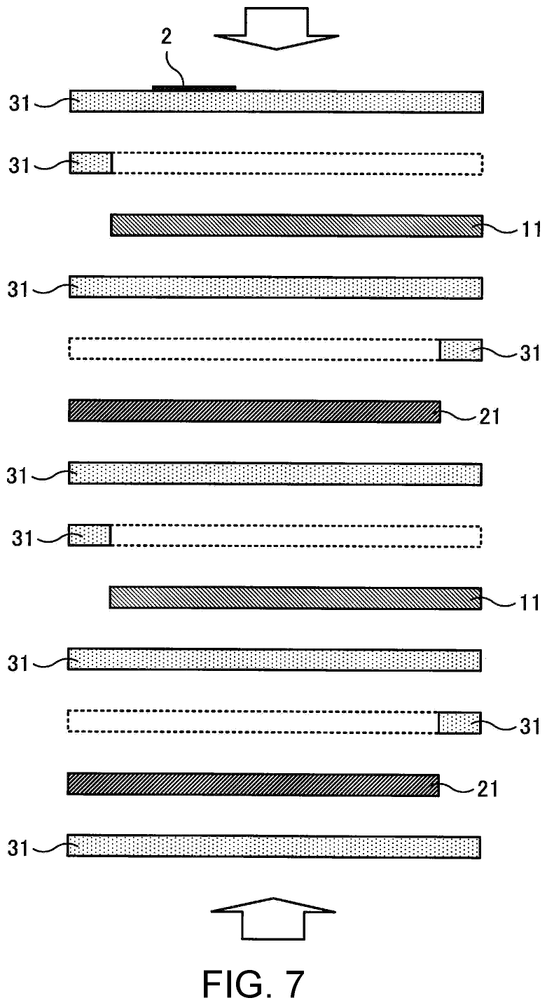

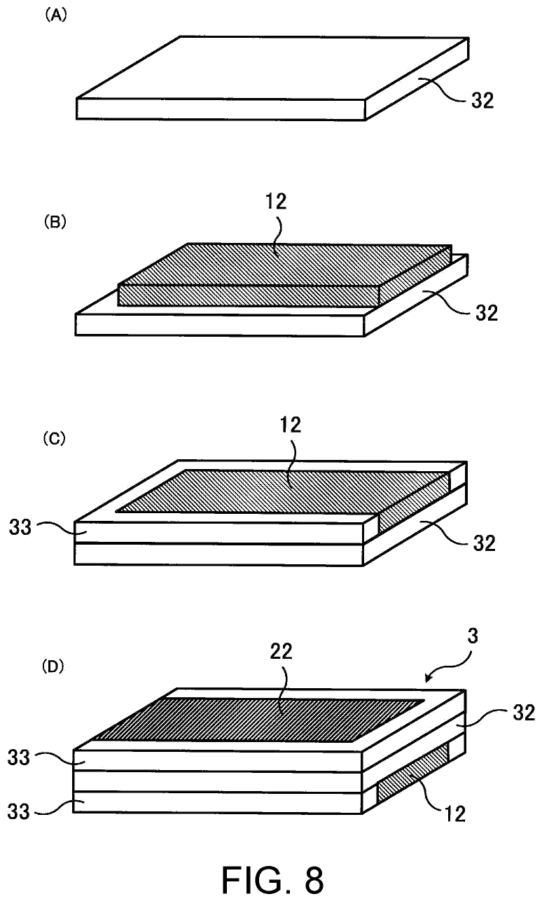

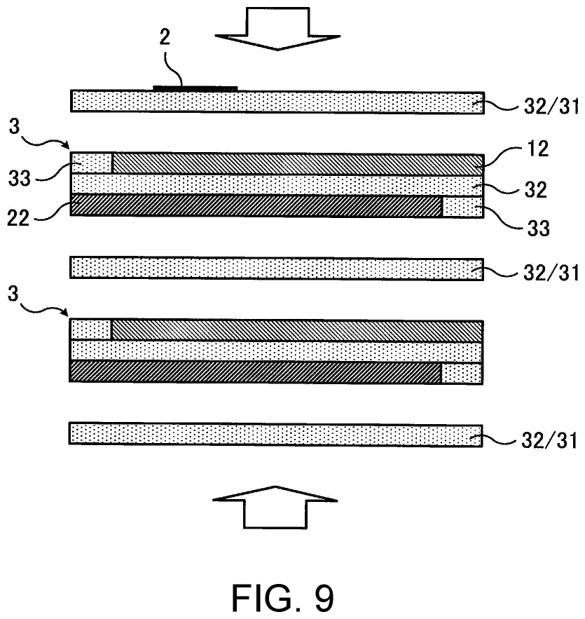

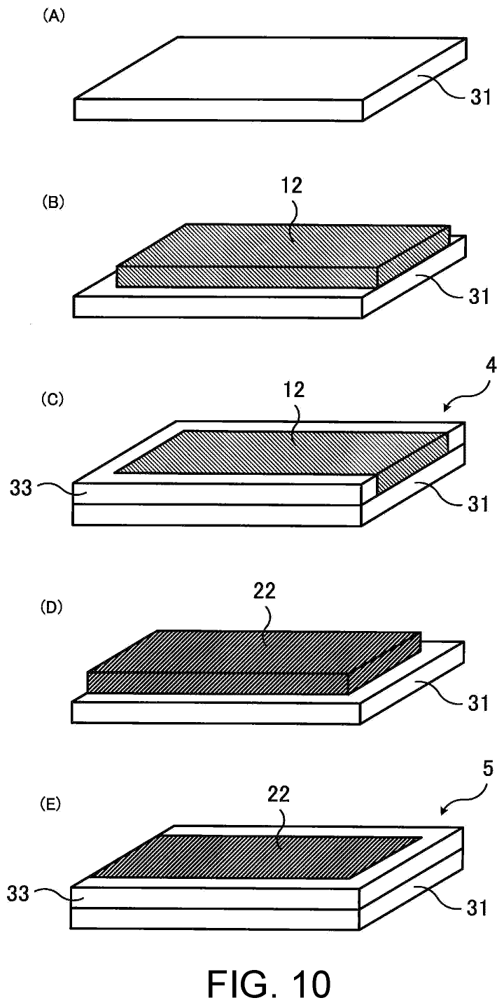

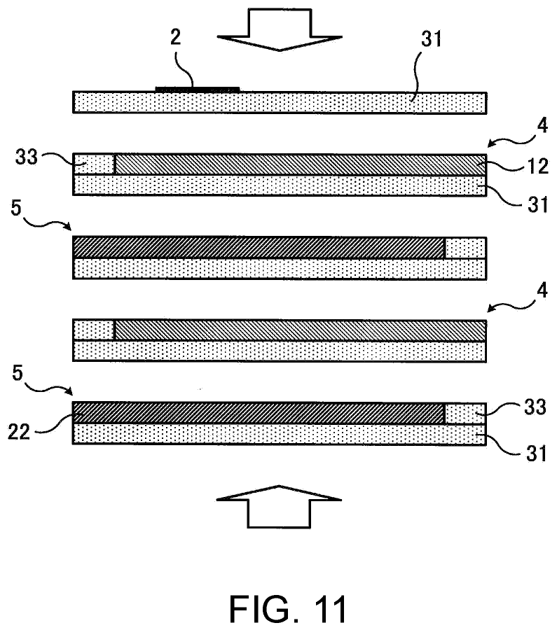

For example, the solid-state battery body 1Aa as shown in (B) of FIG. 5 is formed by a green sheet lamination method (first formation example shown in FIG. 6 and FIG. 7) using the electrolyte layer green sheet, the positive electrode layer green sheet, and the negative electrode layer green sheet as described above. Alternatively, the solid-state battery body 1Aa as shown in (B) of FIG. 5 is formed by a screen printing method (second formation example shown in FIG. 8 and FIG. 9) using the electrolyte layer substrate, the positive electrode layer paste, and the negative electrode layer paste as described above. Alternatively, the solid-state battery body 1Aa as shown in (B) of FIG. 5 is formed by a screen printing method (third formation example shown in FIG. 10 and FIG. 11) using the electrolyte layer green sheet, the positive electrode layer paste, and the negative electrode layer paste as described above.

FIG. 6 and FIG. 7 are diagrams illustrating the first formation example of the solid-state battery body. (A) to (C) of FIG. 6 schematically show perspective views of main parts of the layers included in the solid-state battery body, respectively. FIG. 7 schematically shows a cross-sectional view of main parts in a process of laminating the layers included in the solid-state battery body.

An electrolyte layer green sheet 31 (LAGP green sheet) having a shape as shown in (A) of FIG. 6 is used as the electrolyte layers 30 provided above and below the positive electrode layer 10 and the electrolyte layers 30 provided above and below the negative electrode layer 20 of the solid-state battery body 1Aa as shown in (B) of FIG. 5. The one obtained by the above method is used directly or cut to prepare the electrolyte layer green sheet 31.

A positive electrode layer green sheet 11 having a shape as shown in (B) of FIG. 6 (middle view thereof) is used as the positive electrode layer 10 of the solid-state battery body 1Aa as shown in (B) of FIG. 5. The one obtained by the above method is used directly or cut to prepare the positive electrode layer green sheet 11. Furthermore, an electrolyte layer green sheet 31 having a shape as shown in (B) of FIG. 6 (upper view thereof), that is, a shape capable of surrounding the positive electrode layer green sheet 11 except for one end thereof, is prepared as the electrolyte layer 30 provided in the same layer as the positive electrode layer 10 of the solid-state battery body 1Aa. The electrolyte layer green sheet 31 is prepared by cutting the one obtained by the above method. The positive electrode layer green sheet 11 and the electrolyte layer green sheet 31 prepared may be combined in advance so that the positive electrode layer green sheet 11 is surrounded by the electrolyte layer green sheet 31 except for one end thereof, as shown in (B) of FIG. 6 (lower view thereof).

A negative electrode layer green sheet 21 having a shape as shown in (C) of FIG. 6 (middle view thereof) is used as the negative electrode layer 20 of the solid-state battery body 1Aa as shown in (B) of FIG. 5. The one obtained by the above method is used directly or cut to prepare the negative electrode layer green sheet 21. Furthermore, an electrolyte layer green sheet 31 having a shape as shown in (C) of FIG. 6 (upper view thereof), that is, a shape capable of surrounding the negative electrode layer green sheet 21 except for one end thereof, is prepared as the electrolyte layer 30 provided in the same layer as the negative electrode layer 20 of the solid-state battery body 1Aa. The electrolyte layer green sheet 31 is prepared by cutting the one obtained by the above method. The negative electrode layer green sheet 21 and the electrolyte layer green sheet 31 prepared may be combined in advance so that the negative electrode layer green sheet 21 is surrounded by the electrolyte layer green sheet 31 except for one end thereof, as shown in (C) of FIG. 6 (lower view thereof).

The electrolyte layer green sheet 31, the positive electrode layer green sheet 11, and the negative electrode layer green sheet 21 obtained as described above are laminated in the order as shown in FIG. 7 and thermally compressed. As a result, the basic structure (laminate) of the solid-state battery body 1Aa is formed. A polarity marker 2 is attached to the uppermost electrolyte layer green sheet 31.

For convenience, (B) of FIG. 6 illustrates a state where the positive electrode layer green sheet 11 is surrounded by the electrolyte layer green sheet 31 except for one end thereof. The state where the positive electrode layer green sheet 11 is surrounded by the electrolyte layer green sheet 31 except for one end thereof may be obtained by cutting at a predetermined position after performing the lamination and thermocompression according to the example of FIG. 7. Similarly, for convenience, (C) of FIG. 6 illustrates a state where the negative electrode layer green sheet 21 is surrounded by the electrolyte layer green sheet 31 except for one end thereof. The state where the negative electrode layer green sheet 21 is surrounded by the electrolyte layer green sheet 31 except for one end thereof may be obtained by cutting at a predetermined position after performing the lamination and thermocompression according to the example of FIG. 7.

FIG. 8 and FIG. 9 are diagrams illustrating the second formation example of the solid-state battery body. (A) to (D) of FIG. 8 schematically show perspective views of main parts in a process of forming the layers included in the solid-state battery body. FIG. 9 schematically shows a cross-sectional view of main parts in a process of laminating the layers included in the solid-state battery body.

An electrolyte layer substrate 32 (LAGP substrate) having a shape as shown in (A) of FIG. 8 is prepared by compaction and sintering as described above. As shown in (B) of FIG. 8, a positive electrode layer paste 12 is coated on a portion on one surface of the electrolyte layer substrate 32 by screen printing. After the coating, drying is performed to remove the solvent in the positive electrode layer paste 12. As shown in (C) of FIG. 8, an insulating paste, for example, an electrolyte layer paste 33 containing an oxide solid electrolyte LAGP, is coated on the remainder on one surface of the electrolyte layer substrate 32 by screen printing. After the coating, drying is performed to remove the solvent in the electrolyte layer paste 33.

Further, the coating of the positive electrode layer paste 12 and the electrolyte layer paste 33 by screen printing may be performed multiple times. In this case, the drying for removing the solvent may be performed after each screen printing of the positive electrode layer paste 12 and the electrolyte layer paste 33 or after both screen printings, or may be collectively performed after multiple times of screen printings of the positive electrode layer paste 12 and the electrolyte layer paste 33.

Similar to (A) to (C) of FIG. 8, as shown in (D) of FIG. 8, a negative electrode layer paste 22 is coated on a portion on the other surface of the electrolyte layer substrate 32 by screen printing, and an insulating paste such as the electrolyte layer paste 33 is coated on the remainder on the surface by screen printing. After the coating of the negative electrode layer paste 22 and the coating of the electrolyte layer paste 33, drying is performed to remove the solvent in the negative electrode layer paste 22 and the solvent in the electrolyte layer paste 33.

Further, the coating of the negative electrode layer paste 22 and the electrolyte layer paste 33 by screen printing may be performed multiple times. In this case, the drying for removing the solvent may be performed after each screen printing of the negative electrode layer paste 22 and the electrolyte layer paste 33 or after both screen printings, or may be collectively performed after multiple times of screen printings of the negative electrode layer paste 22 and the electrolyte layer paste 33.

The laminate 3 as shown in (D) of FIG. 8 is alternately laminated with the electrolyte layer substrate 32 or the electrolyte layer green sheet 31 as shown in FIG. 9 and thermally compressed. As a result, the basic structure (laminate) of the solid-state battery body 1Aa is formed. A polarity marker 2 is attached to the uppermost electrolyte layer substrate 32 or electrolyte layer green sheet 31.

For convenience, (B) and (C) of FIG. 8 illustrate a state where a side surface of the positive electrode layer paste 12 is exposed from one side surface of the electrolyte layer substrate 32 and the electrolyte layer paste 33. The state where the side surface of the positive electrode layer paste 12 is exposed from one side surface of the electrolyte layer substrate 32 and the electrolyte layer paste 33 may be obtained by cutting at a predetermined position after performing the lamination and thermocompression according to the example of FIG. 9. Similarly, for convenience, (D) of FIG. 8 illustrates a state where a side surface of the negative electrode layer paste 22 is exposed from one side surface of the electrolyte layer substrate 32 and the electrolyte layer paste 33. The state where the side surface of the negative electrode layer paste 22 is exposed from one side surface of the electrolyte layer substrate 32 and the electrolyte layer paste 33 may be obtained by cutting at a predetermined position after performing the lamination and thermocompression according to the example of FIG. 9.

FIG. 10 and FIG. 11 are diagrams illustrating the third formation example of the solid-state battery body. (A) to (E) of FIG. 10 schematically show perspective views of main parts in a process of forming the layers included in the solid-state battery body. FIG. 11 schematically shows a cross-sectional view of main parts in a process of laminating the layers included in the solid-state battery body.

An electrolyte layer green sheet 31 having a shape as shown in (A) of FIG. 10 is prepared. As shown in (B) of FIG. 10, a positive electrode layer paste 12 is coated on a portion on the electrolyte layer green sheet 31 by screen printing. After the coating, drying is performed to remove the solvent in the positive electrode layer paste 12. As shown in (C) of FIG. 10, an insulating paste such as an electrolyte layer paste 33 is coated on the remainder on the electrolyte layer green sheet 31 by screen printing. After the coating, drying is performed to remove the solvent in the electrolyte layer paste 33.

Further, the coating of the positive electrode layer paste 12 and the electrolyte layer paste 33 by screen printing may be performed multiple times. In this case, the drying for removing the solvent may be performed after each screen printing of the positive electrode layer paste 12 and the electrolyte layer paste 33 or after both screen printings, or may be collectively performed after multiple times of screen printings of the positive electrode layer paste 12 and the electrolyte layer paste 33.

Similarly, an electrolyte layer green sheet 31 having a shape as shown in (A) of FIG. 10 is prepared, and as shown in (D) of FIG. 10, a negative electrode layer paste 22 is coated on a portion on the electrolyte layer green sheet 31 by screen printing. After the coating, drying is performed to remove the solvent in the negative electrode layer paste 22. As shown in (E) of FIG. 10, an insulating paste such as the electrolyte layer paste 33 is coated on the remainder on the electrolyte layer green sheet 31 by screen printing. After the coating, drying is performed to remove the solvent in the electrolyte layer paste 33.

Further, the coating of the negative electrode layer paste 22 and the electrolyte layer paste 33 by screen printing may be performed multiple times. In this case, the drying for removing the solvent may be performed after each screen printing of the negative electrode layer paste 22 and the electrolyte layer paste 33 or after both screen printings, or may be collectively performed after multiple times of screen printings of the negative electrode layer paste 22 and the electrolyte layer paste 33.

The laminate 4 as shown in (C) of FIG. 10 and the laminate 5 as shown in (E) of FIG. 10 are alternately laminated by providing the electrolyte layer green sheet 31 on the uppermost layer as shown in FIG. 11 and thermally compressed. As a result, the basic structure (laminate) of the solid-state battery body 1Aa is formed. A polarity marker 2 is attached to the uppermost electrolyte layer green sheet 31.

For convenience, (B) and (C) of FIG. 10 illustrate a state where a side surface of the positive electrode layer paste 12 is exposed from one side surface of the electrolyte layer green sheet 31 and the electrolyte layer paste 33. The state where the side surface of the positive electrode layer paste 12 is exposed from one side surface of the electrolyte layer green sheet 31 and the electrolyte layer paste 33 may be obtained by cutting at a predetermined position after performing the lamination and thermocompression according to the example of FIG. 11. Similarly, for convenience, (D) and (E) of FIG. 10 illustrate a state where a side surface of the negative electrode layer paste 22 is exposed from one side surface of the electrolyte layer green sheet 31 and the electrolyte layer paste 33. The state where the side surface of the negative electrode layer paste 22 is exposed from one side surface of the electrolyte layer green sheet 31 and the electrolyte layer paste 33 may be obtained by cutting at a predetermined position after performing the lamination and thermocompression according to the example of FIG. 11.

(Firing)

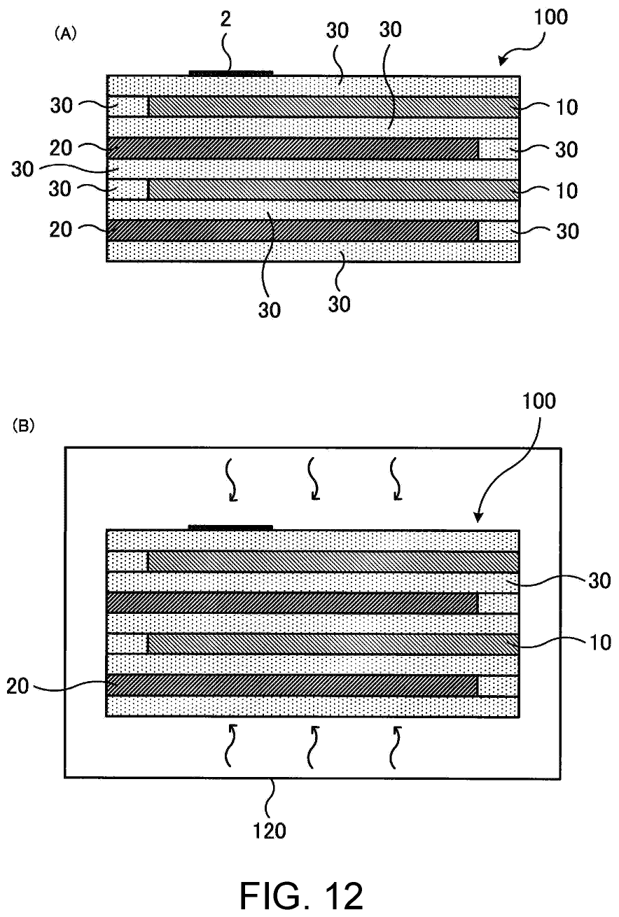

FIG. 12 is a diagram illustrating firing of the basic structure of the solid-state battery body. (A) of FIG. 12 schematically shows a cross-sectional view of main parts of the basic structure of the solid-state battery body. (B) of FIG. 12 schematically shows a cross-sectional view of main parts in a process of firing the basic structure of the solid-state battery body.

By performing the method as shown in FIG. 6 and FIG. 7 above, the method as shown in FIG. 8 and FIG. 9, or the method as shown in FIG. 10 and FIG. 11, a laminate 100, which is the basic structure of the solid-state battery body 1Aa, as shown in (A) of FIG. 12 is obtained. The laminate 100 includes an electrolyte layer 30 before firing (corresponding to the electrolyte layer green sheet 31, the electrolyte layer substrate 32, or the electrolyte layer paste 33 described above), a positive electrode layer 10 before firing (corresponding to the positive electrode layer green sheet 11 or the positive electrode layer paste 12 described above), and a negative electrode layer 20 before firing (corresponding to the negative electrode layer green sheet 21 or the negative electrode layer paste 22 described above).

The obtained laminate 100 is moved into a firing furnace 120 as shown in (B) of FIG. 12. Then, in the firing furnace 120, firing for pyrolyzing (degreasing) the remaining binder or the like is performed on the moved-in laminate 100 in an air atmosphere, and firing for sintering LAGP is further performed in a non-oxidizing atmosphere or an air atmosphere. As a result, the solid-state battery body 1Aa having the electrolyte layer 30, the positive electrode layer 10, and the negative electrode layer 20 after firing is formed.

(Current Collector)

After forming the solid-state battery body 1Aa, the current collector 40 made of a silver (Ag) paste or the like is formed at one end where the positive electrode layer 10 is exposed. Similarly, the current collector 50 made of an Ag paste or the like is formed at the other end of the solid-state battery body 1Aa where the negative electrode layer 20 is exposed. In addition to the Ag paste, a conductive paste containing conductive particles such as various metal particles and carbon particles can also be used for the current collector 40 and the current collector 50. The conductive paste such as the Ag paste is coated on both ends of the solid-state battery body 1Aa, and the firing sinters the conductive particles such as Ag in the conductive paste to form the current collector 40 and the current collector 50. Thus, the current collector 40 connected to the positive electrode layer 10 is formed at one end of the solid-state battery body 1Aa and the current collector 50 connected to the negative electrode layer 20 is formed at the other end of the solid-state battery body 1Aa to form the solid-state battery lA having the configuration as shown in (A) and (B) of FIG. 5.

In the above-mentioned solid-state battery 1A, LCPO obtained by the production method described in the first or second embodiment above, that is, LCPO in which the generation of different phases is suppressed, is used as the positive electrode active material in the positive electrode layer 10 of the solid-state battery body 1Aa. Here, if the LCPO used as the positive electrode active material contains a different phase, it may lead to a decrease in the operating voltage of the positive electrode, a decrease in energy density, or the like, and make it impossible to obtain a solid-state battery that exhibits excellent charge/discharge characteristics. In contrast, in the above-mentioned solid-state battery 1A, LCPO in which the generation of different phases is suppressed is used as the positive electrode active material. As a result, a high-performance chip-type solid-state battery 1A having excellent charge/discharge characteristics is realized.

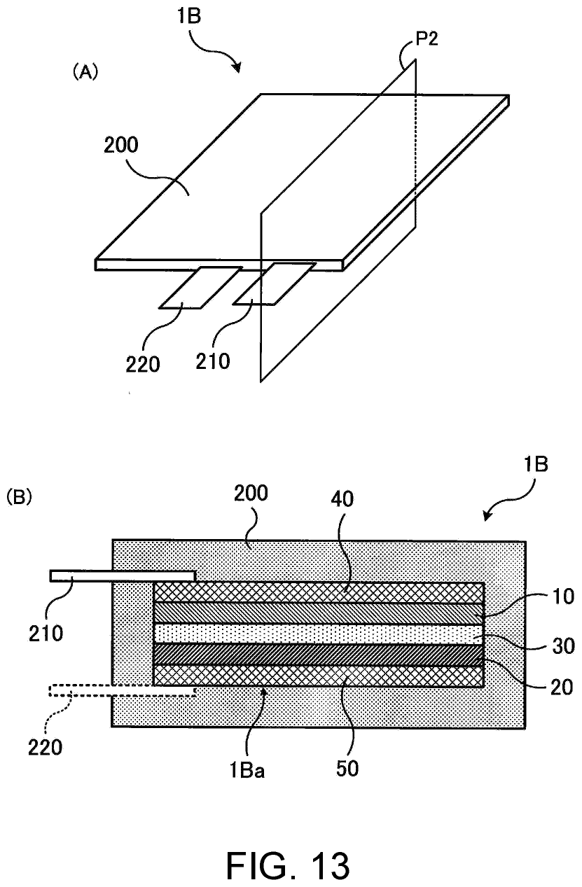

In addition, FIG. 13 is a diagram showing another configuration example of the solid-state battery. (A) of FIG. 13 schematically shows a perspective view of main parts of an example of the solid-state battery. (B) of FIG. 13 schematically shows a cross-sectional view of main parts of an example of the solid-state battery. (B) of FIG. 13 is an example of a cut surface along the plane P2 in (A) of FIG. 13.

The solid-state battery 1B shown in (A) and (B) of FIG. 13 is an example of a thin battery. The solid-state battery 1B has an exterior body 200, and a terminal 210 and a terminal 220 protruding from the exterior body 200 to the outside. For example, a film-shaped, bag-shaped, or box-shaped body formed using a material such as resin, ceramic, and metal coated with an insulating coating can be used as the exterior body 200. A solid-state battery body 1Ba is accommodated inside the exterior body 200. In the solid-state battery 1B, a structure in which the solid-state battery body 1Ba coated with a predetermined insulating material (for example, oxide solid electrolyte) is further coated with the film-shaped, bag-shaped, or box-shaped exterior body 200 may be adopted.

The solid-state battery body 1Ba includes a positive electrode layer 10, a negative electrode layer 20, and an electrolyte layer 30 provided therebetween. The solid-state battery body 1Ba further includes a current collector 40 provided on the positive electrode layer 10, and a current collector 50 provided on the negative electrode layer 20. The electrolyte layer 30, the positive electrode layer 10, the negative electrode layer 20, the current collector 40, and the current collector 50 of the solid-state battery body 1Ba use the same materials as those described for the solid-state battery body 1Aa. The terminal 210 is connected to the current collector 40 on the side of the positive electrode layer 10 of the solid-state battery body 1Ba by using a method such as bonding or welding, and the terminal 220 is connected to the current collector 50 on the side of the negative electrode layer 20 by using a method such as bonding or welding. The solid-state battery body 1Ba is accommodated inside the exterior body 200 in a manner that the tips of the terminals 210 and 220 are exposed to the outside.

In the solid-state battery 1B, LCPO obtained by the production method described in the above first or second embodiment, that is, LCPO in which the generation of different phases is suppressed, is used as the positive electrode active material in the positive electrode layer 10 of the solid-state battery body 1Ba. As a result, a high-performance thin solid-state battery 1B having excellent charge/discharge characteristics is realized.

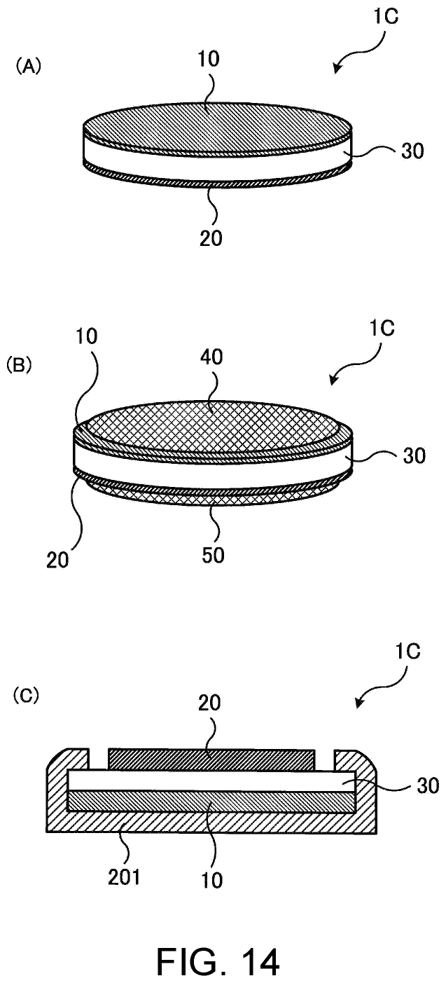

Further, FIG. 14 is a diagram showing yet another configuration example of the solid-state battery. (A) and (B) of FIG. 14 schematically show perspective views of main parts of an example of the solid-state battery, respectively. (C) of FIG. 14 schematically shows a cross-sectional view of main parts of an example of the solid-state battery.

The solid-state battery 1C shown in (A) of FIG. 14 is an example of a coin-shaped or button-shaped battery, and includes a positive electrode layer 10, a negative electrode layer 20, and an electrolyte layer 30 provided therebetween. For example, as shown in (B) of FIG. 14, the solid-state battery 1C may have a form in which the positive electrode layer 10 and the negative electrode layer 20 are provided with the current collector 40 and the current collector 50, respectively. For example, as shown in (C) of FIG. 14, the solid-state battery 1C may be covered with a conductive exterior body 201 that is connected to the positive electrode layer 10 (or the current collector (not shown) provided thereon) and is not connected to the negative electrode layer 20 (or the current collector (not shown) provided thereon). The electrolyte layer 30, the positive electrode layer 10, and the negative electrode layer 20 of the solid-state battery 1C, or even the current collector 40 and the current collector 50 use the same materials as those described for the solid-state battery body 1Aa.

In the solid-state battery 1C, LCPO obtained by the production method as described in the above first or second embodiment, that is, LCPO in which the generation of different phases is suppressed, is used as the positive electrode active material in the positive electrode layer 10. As a result, a high-performance coin-shaped or button-shaped solid-state battery 1C having excellent charge/discharge characteristics is realized.

In addition, the LCPO, which is obtained by the production method as described in the first or second embodiment and in which the generation of different phases is suppressed, is not necessarily used as the positive electrode active material of the chip-type, thin, coin-shaped, or button-shaped solid-state battery as described above, and can also be used as the positive electrode active material for batteries of various shapes such as rectangular and cylindrical.

Furthermore, although the above description illustrates amorphous LAGP as the oxide solid electrolyte used in the electrolyte layer 30, the positive electrode layer 10, and the negative electrode layer 20, the electrolyte layer 30, the positive electrode layer 10, and the negative electrode layer 20 may each contain crystalline LAGP in addition to amorphous LAGP.

LAGP of the electrolyte layer 30 is not limited to the composition of Li_{1.5}Al_{0.5}Ge_{1.5}(PO₄)₃, and NASICON-type LAGP having other compositions such as Li_{1.4}Al_{0.4}Ge_{1.6}(PO₄)₃ may be used. In the electrolyte layer 30, in addition to LAGP, other oxide solid electrolytes such as Li_{1.3}Al_{0.3}Ti_{1.7}(PO₄)₃ which is a type of NASICON-type LATP, garnet-type lithium lanthanum zirconate (Li₇La₃Zr₂O₁₂, hereinafter referred to as “LLZ”), perovskite-type lithium lanthanum titanate (Li_{0.5}La_{0.5}TiO₃, hereinafter referred to as “LLT”), and partially nitrided γ-lithium phosphate (γ-Li₃PO₄, hereinafter referred to as “LiPON”) may also be used.

In addition to LAGP, other oxide solid electrolytes such as LATP, LLZ, LLT, and LiPON may also be used in the positive electrode layer 10 and the negative electrode layer 20 as long as a certain performance is achieved by combining the active materials used.

For example, for the electrolyte layer 30, the positive electrode layer 10, and the negative electrode layer 20, a NASICON-type oxide solid electrolyte represented by the general formula Li₁₊ᵤAlᵤM₂₋ᵤ(PO₄)₃ is suitable. Here, the composition ratio u is in a range of 0<u≤1, and M is one or both of germanium (Ge) and titanium (Ti).

The electrolyte layer 30, the positive electrode layer 10, and the negative electrode layer 20 may use the same type of oxide solid electrolyte or may use different types of oxide solid electrolytes. One type of oxide solid electrolyte may be used for each of the electrolyte layer 30, the positive electrode layer 10, and the negative electrode layer 20, or two or more types of oxide solid electrolytes may be used.

The above are merely examples. Furthermore, many variations and modifications will be possible for those skilled in the art, and the present invention is not limited to the precise configurations and application examples shown and described above. All corresponding modifications and equivalents are considered within the scope of the present invention according to the appended claims and their equivalents.

### REFERENCE SIGNS LIST

1A, 1B, 1C solid-state battery

1Aa, 1Ba solid-state battery body

2 polarity marker

3, 4, 5, 100 laminate

10 positive electrode layer

11 positive electrode layer green sheet

12 positive electrode layer paste

20 negative electrode layer

21 negative electrode layer green sheet

22 negative electrode layer paste

30 electrolyte layer

31 electrolyte layer green sheet

32 electrolyte layer substrate

33 electrolyte layer paste

40, 50 current collector

120 firing furnace

200, 201 exterior body

210, 220 terminal

1. A production method of lithium cobalt pyrophosphate, comprising:
preparing powders of a lithium compound, a cobalt compound, and a phosphorus compound in amounts based on a composition of lithium cobalt pyrophosphate at a first temperature, and mixing while adding water at the first temperature to obtain a first material;
mixing the first material at a second temperature higher than the first temperature to obtain a second material; and
firing the second material at a third temperature higher than the second temperature.

2. The production method of lithium cobalt pyrophosphate according to claim 1, wherein an amount of water contained in the first material is in a range of 2.0 wt % to 38.3 wt % of a total weight of the powders.

3. The production method of lithium cobalt pyrophosphate according to claim 1, wherein the second temperature is in a range of 40° C. to 60° C.

4. The production method of lithium cobalt pyrophosphate according to claim 1, wherein the third temperature is in a range of 650° C. to 690° C.

5. The production method of lithium cobalt pyrophosphate according to claim 1, comprising drying at a fourth temperature higher than the second temperature and lower than the third temperature before firing at the third temperature.

6. The production method of lithium cobalt pyrophosphate according to claim 1, wherein the first material comprises lithium phosphate, and
the second material comprises ammonium cobalt phosphate.

7. A production method of lithium cobalt pyrophosphate, comprising:
preparing powders of a lithium compound, a cobalt compound, and a phosphorus compound in amounts based on a composition of lithium cobalt pyrophosphate at a first temperature, and mixing while adding water at a second temperature higher than the first temperature to obtain a first material; and
firing the first material at a third temperature higher than the second temperature.

8. The production method of lithium cobalt pyrophosphate according to claim 7, wherein an amount of water contained in the first material is in a range of 14.9 wt % to 95.8 wt % of a total weight of the powders.

9. The production method of lithium cobalt pyrophosphate according to claim 7, wherein the second temperature is in a range of 40° C. to 60° C.

10. The production method of lithium cobalt pyrophosphate according to claim 7, wherein the third temperature is in a range of 650° C. to 690° C.

11. The production method of lithium cobalt pyrophosphate according to claim 7, comprising drying at a fourth temperature higher than the second temperature and lower than the third temperature before firing at the third temperature.

12. The production method of lithium cobalt pyrophosphate according to claim 7, wherein the first material comprises lithium phosphate and ammonium cobalt phosphate.

13. A production method of a solid-state battery, comprising:
forming a positive electrode active material comprising lithium cobalt pyrophosphate;
forming a laminate which comprises a positive electrode layer containing the positive electrode active material, a negative electrode layer, and an electrolyte layer provided between the positive electrode layer and the negative electrode layer; and
firing the laminate,
wherein forming the positive electrode active material comprises:
preparing powders of a lithium compound, a cobalt compound, and a phosphorus compound in amounts based on a composition of the lithium cobalt pyrophosphate at a first temperature, and mixing while adding water at the first temperature to obtain a first material;
mixing the first material at a second temperature higher than the first temperature to obtain a second material; and
firing the second material at a third temperature higher than the second temperature.

14. A production method of a solid-state battery, comprising:
forming a positive electrode active material comprising lithium cobalt pyrophosphate;
forming a laminate which comprises a positive electrode layer containing the positive electrode active material, a negative electrode layer, and an electrolyte layer provided between the positive electrode layer and the negative electrode layer; and
firing the laminate,
wherein forming the positive electrode active material comprises:
preparing powders of a lithium compound, a cobalt compound, and a phosphorus compound in amounts based on a composition of the lithium cobalt pyrophosphate at a first temperature, and mixing while adding water at a second temperature higher than the first temperature to obtain a first material; and
firing the first material at a third temperature higher than the second temperature.
